(19) United States
(12) Patent Application Publication
(10) Pub. No.: US 2012/0196264 A1
(43) Pub. Date: Aug. 2, 2012

(54) SOP Training Simulation Method and System

(76) Inventors: Chuan-Lang Lin, Kaohsiung (TW); Hsiu-Feng Huang, Kaohsiung (TW)

(21) Appl. No.: 13/018,508

(22) Filed: Feb. 1, 2011

(51) Int. Cl. G09B 7/00

(52) U.S. Cl. 434/350; 434/323; 434/362

(57) ABSTRACT

An SOP training simulation method includes the steps of: executing a predetermined simulation file to display a file page on a screen display unit; utilizing an input unit with a first operation mode to input and directly preset first procedure data of predetermined training simulation; utilizing the input unit with a second operation mode to input second procedure data of response simulation on the file page; comparing the first procedure data with the second procedure data to evaluate the training simulation. The SOP training simulation system includes a control unit to execute the above steps.

### BACKGROUND OF THE INVENTION

1. Field of the Invention

The present invention relates to an SOP (Standard Operation Procedure) training simulation method and a system thereof. More particularly, the present invention relates to the method and system of SOP training simulation, executing an SOP training operation directly on at least one correspondingly-executed simulation file page.

2. Description of the Related Art

U.S. patent application publication No. 20070248937, entitled “Operation training simulation system for computer numerical control (CNC) machine,” discloses an operation training simulation system, including a physical control device for inputting control and operation commands, a software simulator connected with the physical control device, a transmission apparatus connecting the physical control device with the software simulator and a simulation display electrically connected to the software simulator. The software simulator generates machining and operation simulations based on the inputted control and operation conditions through the physical control device, and the simulation display visualizes the machining and operation simulations generated by the software simulator. Therefore, using the operation training simulation system for CNC machine not only eliminates the consumptive materials cost but also solve the personal injury problem. Consequently, the learning efficiency of the trainees and the familiarization to machine are raised in this way. However, the operation training simulation system requires utilizing the physical control device for simulation that results in a systematic design limit. Hence, the operation training simulation system is unsuitable for using an input tool to execute an SOP training operation directly on a correspondingly-executed simulation file page.

Taiwanese patent No. I327300, entitled “Simulated learning software and method for making the same,” discloses a method for making simulated learning software for making a teaching material executed on an information system which comprises a display device having a display screen. The method includes the steps of listing all of the evens of the teaching material; creating an operation area and a response area on the display screen; defining an even of the teaching material in the operation area; defining a response corresponding to the defined even in the response area; judging whether all of the evens of the teaching material have been defined, if not, re-proceeding the steps of defining an even of the teaching material in the operation area and defining a response corresponding to the defined even in the response area until all evens have been defined; and making the teaching material to be a executing file or a network page. However, the simulation method is unsuitable for using an input tool to execute an SOP training operation directly on a correspondingly-executed simulation file page.

U.S. patent application publication No. 20100311028, entitled “Dental Implant Surgical Training Simulation System,” discloses a bone implant surgery system which is used for simulating a dental surgical procedure having a display that shows placing a simulated bone implant at a simulated implant site on a living body by using a simulated surgical tool holding the simulated bone implant. At least one hand-held haptic device is used to control the surgical tool and at least one controller is specifically configured to cause movement of the surgical tool on the display based on motions of the haptic device and to cause haptic feedback to a user holding the haptic device depending on the position of the surgical tool on the display. A user may then review and evaluate the results of the surgical simulation. However, the surgical training simulation system requires utilizing the hand-held haptic device for simulation that results in a systematic design limit. Hence, the surgical training simulation system is unsuitable for using an input tool to execute an SOP training operation directly on a correspondingly-executed simulation file page.

U.S. patent application publication No. 20070248937, No. 20070248937 and Taiwanese patent No. I327300 are incorporated herein by reference for purposes including, but not limited to, indicating the background of the present invention and illustrating the state of the art. However, there exists a need of providing a function of executing an SOP training operation directly on a correspondingly-executed simulation file page.

As is described in greater detail below, the present invention provides an interactive SOP training simulation method and a system thereof. A predetermined simulation-related file is executed to display on a screen and a format of the predetermined simulation-related file is recognized to execute a training simulation procedure on a file page thereof to produce a training simulation file. The training simulation file can be executed with the aid of its original browser in such a way as to mitigate and overcome the above problem.

### SUMMARY OF THE INVENTION

The primary objective of this invention is to provide an interactive SOP training simulation method and a system thereof. A predetermined simulation-related file is executed to display on a screen and a format of the predetermined simulation-related file is recognized to execute a training simulation procedure on a file page thereof to produce a training simulation file. Accordingly, the SOP training simulation method and system is successful in simplifying the procedure of the SOP training simulation.

The SOP training simulation method in accordance with an aspect of the present invention includes the steps of:

executing at least one predetermined simulation file to display a file page on a screen display unit, and recognizing a format of the predetermined simulation file so as to access the predetermined simulation file via the file page;

utilizing an input unit with a first operation mode to input and directly preset first procedure data of predetermined training simulation which is synchronously displayed on the file page, and storing the first procedure data in a data storage unit;

utilizing the input unit with a second operation mode to input second procedure data of response simulation on the file page; and

comparing the first procedure data with the second procedure data to evaluate the training simulation.

In a separate aspect of the present invention, the file page is executed by a computer program.

In a further separate aspect of the present invention, the input unit selected from a mouse, a key board, a touch panel, a handwriting recognition device, a voice input device or a wireless input device.

In yet a further separate aspect of the present invention, the first operation mode includes a click mode, a drag mode and a text-inputting mode.

In yet a further separate aspect of the present invention, the screen display unit includes a computer display, a TV and a monitor.

In yet a further separate aspect of the present invention, the first procedure data includes a sequence of clicks or double-clicks, a plurality of choice buttons, a plurality of Q&A windows and a plurality of connection lines.

The SOP training simulation system in accordance with an aspect of the present invention includes:

at least one predetermined simulation file being executed to display a file page on a screen display unit by a control unit so as to provide a practice training process;

a first operation mode utilized to directly preset first procedure data of predetermined training simulation on the file page;

a data storage unit used to stored the first procedure data; and

a second operation mode utilized to directly input second procedure data of response simulation on the file page, the second operation mode corresponding to the first operation mode;

wherein the control unit is operated to compare the second procedure data with the first procedure data.

In a separate aspect of the present invention, a single input unit or different input units are used to execute the first operation mode and the second operation mode.

Further scope of the applicability of the present invention will become apparent from the detailed description given hereinafter. However, it should be understood that the detailed description and specific examples, while indicating preferred embodiments of the invention, are given by way of illustration only, since various modifications will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic flowchart of an SOP training simulation method in accordance with a preferred embodiment of the present invention.

FIG. 2 is a schematic block diagram of an SOP training simulation system in accordance with a preferred embodiment of the present invention.

FIG. 3 is a schematic view of a simulation image of electrode connection steps of electocaridograph equipment applied in the SOP training simulation method and system in accordance with the preferred embodiment of the present invention.

FIG. 4 is a schematic view of a simulation image of hand-washing steps applied in the SOP training simulation method and system in accordance with the preferred embodiment of the present invention.

### DETAILED DESCRIPTION OF THE INVENTION

It is noted that an interactive SOP training simulation method and a system thereof in accordance with the preferred embodiment of the present invention is suitable for various SOP training simulation systems, for example, including surgical training simulation systems, nursing training simulation systems, medicine training simulation systems, accident prevention and safety management training simulation systems, tool-operation training simulation systems and vehicle-driving training simulation systems which are not limitative of the present invention.

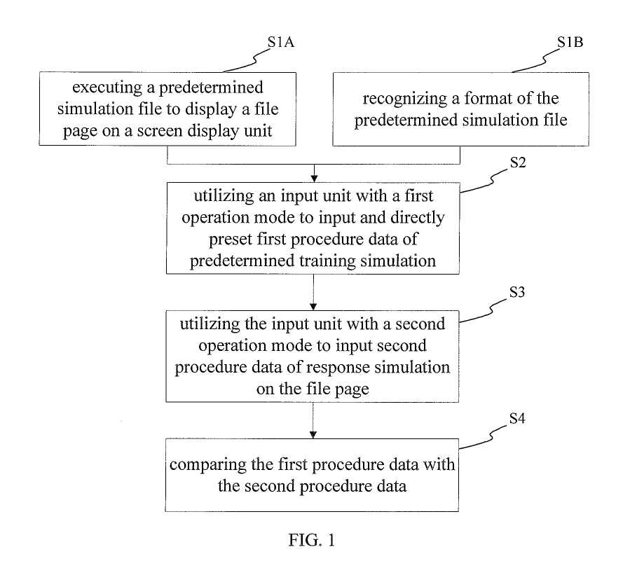

FIG. 1 shows a schematic flowchart of an SOP training simulation method in accordance with a preferred embodiment of the present invention. Referring to FIG. 1, the SOP training simulation method includes the first step S1A: executing at least one predetermined simulation file to display a file page on a screen display unit. In a preferred embodiment, the predetermined simulation file is selected from a training file which is produced from an electronic file or a series of electronic files. By way of example, the electronic file is selected from a HTML-format file, a PDF-format file, a graphic file (for example: JPEG-format file) a video and audio file (for example: MPEG-format file), or a multimedia file.

With continued reference to FIG. 1, the SOP training simulation method includes the first step S1B: further recognizing a format of the predetermined simulation file so as to suitably access the predetermined simulation file via the file page on the screen display unit while executing the step S1A. Consequently, the predetermined simulation file can be accessed and edited without the aid of utilizing its original browser.

Still referring to FIG. 1, the SOP training simulation method includes the second step S2: utilizing an input unit with a first operation mode to input and directly preset first procedure data of predetermined training simulation which is synchronously displayed on the file page, and storing the first procedure data in a data storage unit as a training simulation file or a customized-training simulation file with predetermined formats. In presetting operation, final results of the first procedure data will not remain to display on the file page, the screen display unit or other displays. In a preferred embodiment, the first procedure data are selected from various SOP data and the training simulation file.

Still referring to FIG. 1, the SOP training simulation method includes the third step S3: utilizing the input unit or other input devices with a second operation mode to input second procedure data of response simulation on the file page by a trainee while executing the training simulation file. It will be understood that the second procedure data correspond with the second procedure data. In this preferred embodiment, operational results of the second procedure data will be displayed on the screen display unit or other display units.

Still referring to FIG. 1, the SOP training simulation method includes the fourth step S4: finally, comparing the first procedure data with the second procedure data to evaluate the training simulation. In a preferred embodiment, each score of the second procedure data is automatically calculated. Qualification information will be generated if the second procedure data has a total score greater than a predetermined threshold value of correctness with respect to the first procedure data. Conversely, failure information will be generated if the second procedure data has a total score lower than the predetermined threshold value.

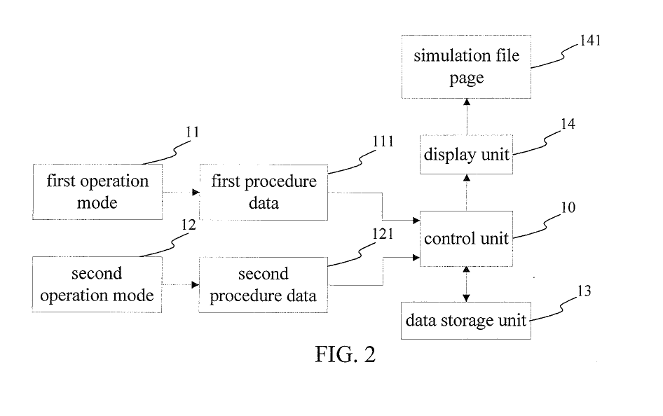

Turning now to FIG. 2, a schematic block diagram of an SOP training simulation system in accordance with a preferred embodiment of the present invention is shown. The SOP training simulation system includes a control unit 10, a first operation mode 11, a second operation mode 12, a storage unit 13, a screen display unit 14 and a simulation file page 141. The control unit 10 electrically connects with the first operation mode 11 and the second operation mode 12, as best shown in the left side of FIG. 2. In addition, the control unit 10 electrically connects with the storage unit 13 and the screen display unit 14, as best shown in the right side of FIG. 2.

With continued reference to FIG. 2, the control unit 10 is operated to control the simulation file page 141 to be displayed on the screen display unit 14 such that a training simulation environment is provided. By way of example, a trainer can use the training simulation environment to preset correct steps of surgical operation for executing a surgical training simulation test. In a preferred embodiment, the simulation file page 141 is generated from an electronic file or a series of electronic files, and the screen display unit 14 includes a computer display, a TV and a monitor.

Still referring to FIG. 2, an input unit (not shown) is controlled by the control unit 10 to execute the first operation mode 11 for inputting first procedure data 111 directly on the simulation file page 141, displayed on the screen display unit 14, into the SOP training simulation system. In presetting operation, final results of the first procedure data 111 will not remain to display on the simulation file page 141 such that trainees cannot review the preset first procedure data 111 and related information on the simulation file page 141. In a preferred embodiment, the input unit selected from a mouse, a key board, a touch panel, a handwriting recognition device, a voice input device or a wireless input device. Furthermore, the operation mode 11 includes a click mode, a drag mode and a text-inputting mode.

Still referring to FIG. 2, the storage unit 13 is used to store the preset first procedure data 111, and is selected from a memory device. In a preferred embodiment, the first procedure data 111 includes a sequence of clicks or double-clicks, a plurality of choice buttons, Q&A windows, connection lines, interactive icons or widgets.

Still referring to FIG. 2, the input unit is controlled by the control unit 10 to execute the second operation mode 12 for inputting second procedure data 121 directly on the simulation file page 141, where the first procedure data 111 are preset, into the SOP training simulation system. In simulating operation, the second procedure data 121 correspond with the first procedure data 111. In a preferred embodiment, the first operation mode 11 and the second operation mode 12 are executed by separate input units or the same input unit.

Still referring to FIG. 2, once completely input into the SOP training simulation system, the control unit 10 is operated to automatically compare the second procedure data 121 with the first procedure data 111, thereby generating a degree of correctness and reference index (for example: learning assessment index). Finally, the first procedure data 111, the second procedure data 121 and the results are stored in the storage unit 13.

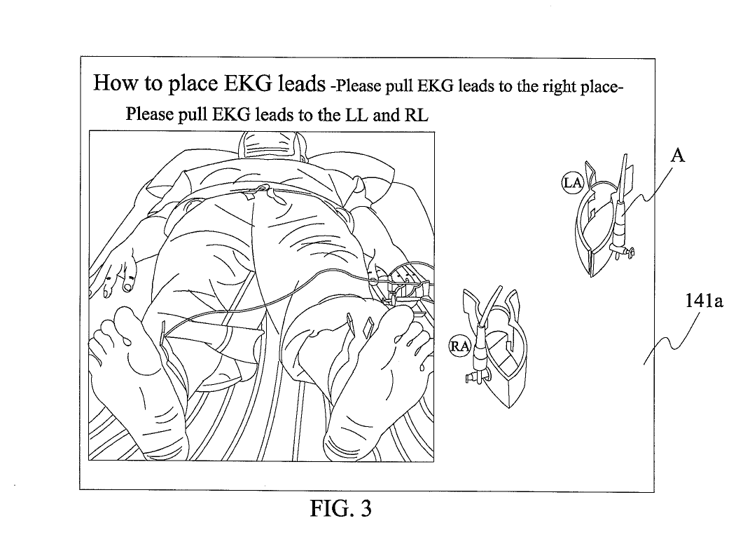

Turning now to FIG. 3, a schematic view of a simulation image of electrode connection steps of electocaridograph equipment applied in the SOP training simulation method and system in accordance with the preferred embodiment of the present invention. Referring again to FIGS. 2 and 3, the simulation file page 141 is selected from a simulation image141a of a series of electrode connection steps of electocaridograph equipment with electrode objects identified as “A” (as best shown in FIG. 3) displaying on the screen display unit 14. In presetting operation, the first procedure data 111 can be preset on the simulation image141a by means of the first operation mode 11.

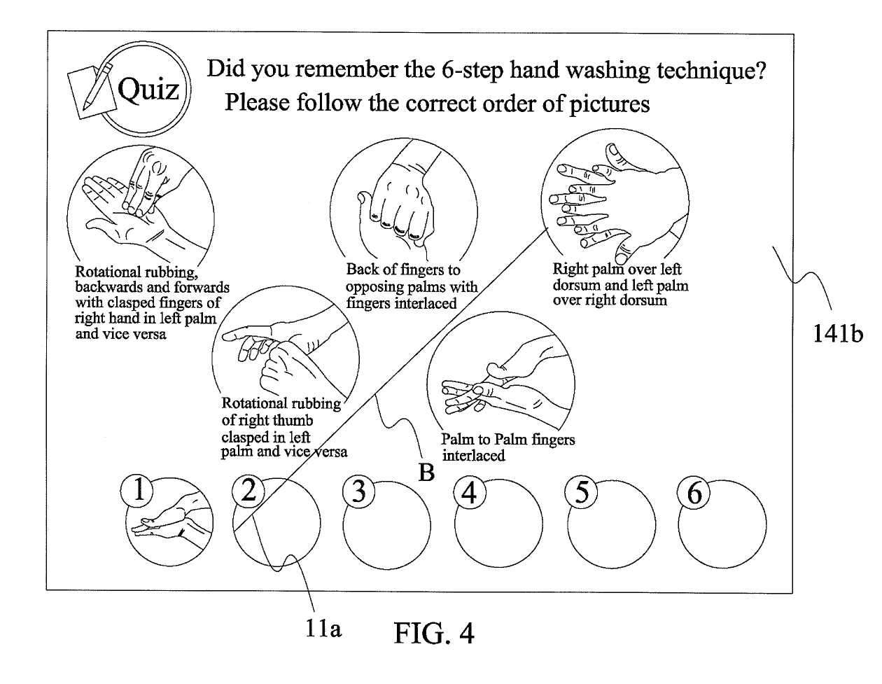

Turning now to FIG. 4, a schematic view of a simulation image of hand-washing steps applied in the SOP training simulation method and system in accordance with the preferred embodiment of the present invention. Referring again to FIGS. 2 and 4, the simulation file page 141 is selected from a simulation image141b of a series of hand-washing steps (as best shown in FIG. 4) displaying on the screen display unit 14. In presetting operation, the first procedure data 111 can be preset on the simulation image141b by means of the first operation mode 11 which is a dragging mode 11a (as best shown in FIG. 4) to drag a connection line identified as “B” on the simulation image141b.

Although the invention has been described in detail with reference to its presently preferred embodiment(s), it will be understood by one of ordinary skill in the art that various modifications can be made without departing from the spirit and the scope of the invention, as set forth in the appended claims.

What is claimed is:

1. An SOP training simulation method, comprising the steps of:
executing at least one predetermined simulation file to display a file page on a screen display unit, and recognizing a format of the predetermined simulation file so as to access the predetermined simulation file via the file page;
utilizing an input unit with a first operation mode to input and directly preset first procedure data of predetermined training simulation which is synchronously displayed on the file page, and storing the first procedure data in a data storage unit;
utilizing the input unit with a second operation mode to input second procedure data of response simulation on the file page; and
comparing the first procedure data with the second procedure data to evaluate the training simulation.

2. The SOP training simulation method as defined in claim 1, wherein the file page is executed by a computer program.

3. The SOP training simulation method as defined in claim 1, wherein the input unit selected from a mouse, a key board, a touch panel, a handwriting recognition device, a voice input device or a wireless input device.

4. The SOP training simulation method as defined in claim 1, wherein the first operation mode includes a click mode, a drag mode and a text-inputting mode.

5. The SOP training simulation method as defined in claim 1, wherein the screen display unit includes a computer display, a TV and a monitor.

6. The SOP training simulation method as defined in claim 5, wherein the first procedure data includes a sequence of clicks or double-clicks, a plurality of choice buttons, a plurality of Q&A windows and a plurality of connection lines.

7. An SOP training simulation system comprising:
at least one predetermined simulation file being executed to display a file page on a screen display unit by a control unit so as to provide a practice training process;
a first operation mode utilized to directly preset first procedure data of predetermined training simulation on the file page;
a data storage unit used to stored the first procedure data; and
a second operation mode utilized to directly input second procedure data of response simulation on the file page, the second operation mode corresponding to the first operation mode;
wherein the control unit is operated to compare the second procedure data with the first procedure data.

8. The SOP training simulation system as defined in claim 7, wherein the file page is executed by a computer program.

9. The SOP training simulation system as defined in claim 7, wherein the first operation mode includes a click mode, a drag mode and a text-inputting mode.

10. The SOP training simulation system as defined in claim 7, wherein the screen display unit includes a computer display, a TV and a monitor.

11. The SOP training simulation system as defined in claim 7, wherein the first procedure data includes a sequence of clicks or double-clicks, a plurality of choice buttons, a plurality of Q&A windows and a plurality of connection lines.

12. The SOP training simulation system as defined in claim 7, wherein a single input unit or different input units are used to execute the first operation mode and the second operation mode.

13. The SOP training simulation system as defined in claim 12, wherein the input unit selected from a mouse, a key board, a touch panel, a handwriting recognition device, a voice input device or a wireless input device.
